(19) United States
(12) Patent Application Publication
(10) Pub. No.: US 2011/0074205 A1
(43) Pub. Date: Mar. 31, 2011

(54) PUMP UNIT FOR ELECTRONICALLY CONTROLLED BRAKE SYSTEM

(75) Inventors: Yong Suk HWANG, Seoul (KR); Seong Ho CHOI, Gyunggi-do (KR); Sang Cheol LEE, Gyeonggi-do (KR)

(73) Assignee: MANDO CORPORATION

(21) Appl. No.: 12/888,845

(22) Filed: Sep. 23, 2010

(30) Foreign Application Priority Data
Sep. 25, 2009 (KR) 10-2009-91179

(51) Int. Cl. B60T 13/16

(52) U.S. Cl. 303/6.01

(57) ABSTRACT

Disclosed is a pump unit for an electronically controlled brake system. The pump unit is operated by a motor having a shaft to be rotated about a rotating axis, and the shaft includes a concentric shaft portion and an eccentric portion integrally formed with each other. An eccentric bearing is coupled to the concentric shaft portion and a concentric bearing is coupled to the eccentric portion, to reduce hydraulic pulsation during operation of pumps and achieve rapid generation of hydraulic pressure.

### CROSS-REFERENCE TO RELATED APPLICATION

This application claims the benefit of Korean Patent Application No. 2009-0091179, filed on Sep. 25, 2009 in the Korean Intellectual Property Office, the disclosure of which is incorporated herein by reference.

### BACKGROUND

1. Field

Embodiments of the present invention relate to a pump unit for an electronically controlled brake system, which has an improved pump arrangement, thereby reducing hydraulic pulsation during operation of a pump and enabling rapid generation of hydraulic pressure.

2. Description of the Related Art

Generally, electronically controlled brake systems are devised to achieve strong and stabilized brake force by effectively preventing vehicle slip. A variety of electronically controlled brake systems have been developed. Examples of the electronically controlled brake systems include an Anti-Lock Brake System (ABS) to prevent wheel slip upon braking, a Brake Traction Control System (BTCS) to prevent wheel slip upon sudden acceleration of a vehicle, and a Vehicle Dynamic Control system (VDC) that is a combination of the ABS and BTCS to stably maintain traveling of a vehicle by controlling hydraulic brake pressure.

A conventional electronically controlled brake system includes a plurality of solenoid valves to control hydraulic brake pressure transmitted to hydraulic brakes provided at wheels, low-pressure and high-pressure accumulators in which oil discharged from the hydraulic brakes is temporarily stored, a motor and pumps to forcibly pump the oil in the low-pressure accumulator, and an Electronic Control Unit (ECU) to control operations of the solenoid valves and motor. All the above mentioned elements are received in a compact aluminum modulator block.

In operation, the oil in the low-pressure accumulator is pressurized and pumped to the high-pressure accumulator via operation of the pumps. As the pressurized oil is transmitted to the hydraulic brakes or a master cylinder assembly, electronic control of wheels is carried out.

The above described conventional electronically controlled brake system, however, is of a dual pump type in which a single motor is connected to two pumps. That is, whenever a rotating shaft of the motor rotates once, the pumps respectively perform a suction stroke and discharge stroke once to supply the pressurized oil to each hydraulic circuit. This may cause an excessive hydraulic pulsation amplitude at a master cylinder during the discharge stroke of the respective pumps and also, the pumps may have difficulty in rapid generation of hydraulic brake pressure required to control wheels.

### SUMMARY

Therefore, it is an aspect of the present invention to provide an electronically controlled brake system, which has an improved pump arrangement, thereby reducing hydraulic pulsation during operation of a pump and achieving rapid generation of hydraulic pressure.

Additional aspects of the invention will be set forth in part in the description which follows and, in part, will be obvious from the description, or may be learned by practice of the invention.

In accordance with an aspect of the present invention, a pump unit for an electronically controlled brake system is connected to first and second hydraulic circuits that connect a master cylinder assembly and a plurality of brake cylinders to each other to define closed circuits, and is operated by a motor having a shaft to be rotated about a rotating axis, wherein the shaft includes a concentric shaft portion and an eccentric portion integrally formed with each other, an eccentric bearing coupled to the concentric shaft portion, and a concentric bearing coupled to the eccentric portion.

The concentric bearing and the eccentric bearing may be press-fitted respectively.

The pump unit may include first to third pumps arranged on a first plane, which intersects at a right angle with the rotating axis at a position corresponding to the concentric bearing, so as to be connected to the concentric bearing, and fourth to sixth pumps arranged on a second plane, which intersects at a right angle with the rotating axis at a position corresponding to the eccentric bearing, so as to be connected to the eccentric bearing.

Three pumps of the first to sixth pumps may be connected to the first hydraulic circuit, and the remaining three pumps may be connected to the second hydraulic circuit.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a hydraulic system diagram of an electronically controlled brake system in accordance with an embodiment of the present invention;

FIG. 2 is an exploded perspective view illustrating a motor in accordance with an embodiment of the present invention;

FIG. 3 is a perspective view schematically illustrating the arrangement of a motor and pump unit in accordance with an embodiment of the present invention; and

FIG. 4 is a perspective view schematically illustrating the connection of a pump unit and hydraulic circuits in accordance with an embodiment of the present invention.

### DETAILED DESCRIPTION

Reference will now be made in detail to the embodiments of the present invention, examples of which are illustrated in the accompanying drawings, wherein like reference numerals refer to like elements throughout.

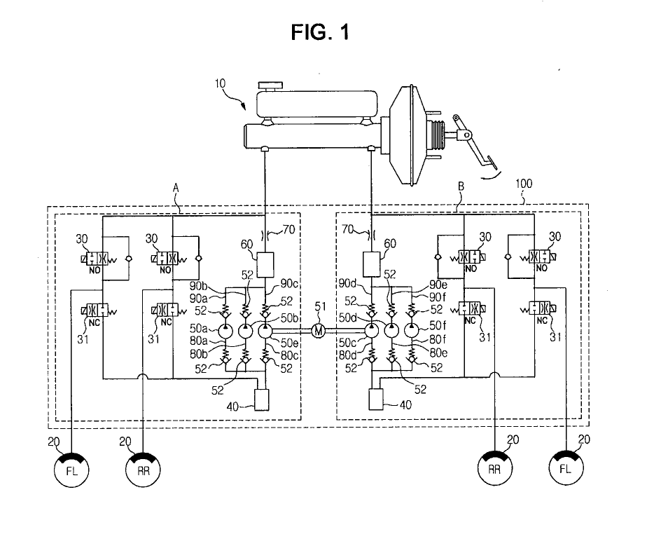

FIG. 1 is a hydraulic system diagram of an electronically controlled brake system in accordance with the embodiment of the present invention.

As illustrated in FIG. 1, the electronically controlled brake system in accordance with the embodiment of the present invention includes a master cylinder assembly 10 to provide brake force, a plurality of brake cylinders 20 to execute a braking operation, and a first hydraulic circuit A and second hydraulic circuit B to connect the master cylinder assembly 10 and the plurality of brake cylinders 20 to each other so as to form closed circuits. The first hydraulic circuit A and second hydraulic circuit B have the same arrangement and thus, a description of the second hydraulic circuit B will be omitted hereinafter except for specially mentioned cases.

The hydraulic circuits A and B respectively include a plurality of solenoid valves 30 and 31 to control intermittent transmission of hydraulic brake pressure from the master cylinder assembly 10 to the respective brake cylinders 20, and a low-pressure accumulator 40 in which oil returned from the brake cylinders 20 is temporarily stored.

The electronically controlled brake system of the present embodiment further includes a pump unit 50 to pressurize and recirculate the oil stored in the low-pressure accumulator 40, a motor 51 to drive the pump unit 50, and high-pressure accumulators 60 to alleviate pressure pulsation of the oil discharged from the pump unit 50.

The pump unit 50 includes a first pump 50a, a second pump 50b, a third pump 50c, a fourth pump 50d, a fifth pump 50e and a sixth pump 50f. The first pump 50a, second pump 50b and fifth pump 50e are connected to the first hydraulic circuit A, and the third pump 50c, fourth pump 50d and sixth pump 50f are connected to the second hydraulic circuit B. The respective pumps 50a, 50b, 50c, 50d, 50e and 50f are provided at suction and discharge sides thereof with check valves 52 to prevent backflow.

All the above mentioned constituent elements are received in a compact state in a cuboidal aluminum modulator block 100. The modulator block 100 contains a plurality of paths to connect these constituent elements to each other.

The solenoid valves 30 and 31 are divided into normal open type solenoid valves 30 (hereinafter, referred to as “NO type solenoid valves”), which are located at upstream paths of the brake cylinders 20 and are normally kept in an open state, and normal close type solenoid valves 31 (hereinafter, referred to as “NC type solenoid valves”) which are located at downstream paths of the brake cylinders 20 and are normally kept in a closed state.

The low-pressure accumulators 40 are arranged at paths connected between downstream sides of the NC type solenoid valves 31 and the pump unit 50. When the brake cylinders 20 generate reduced brake pressure, the low-pressure accumulators 40 temporarily store the oil returned from the brake cylinders 20 through the opened NC type solenoid valves 31. The high-pressure accumulators 60 are arranged at paths connected between upstream sides of the NO type solenoid valves 30 and the pump unit 50 and serve as damping chambers to alleviate pressure pulsation of the oil discharged from the pump unit 50. Reference numeral 70 represents an orifice to stabilize fluid flow.

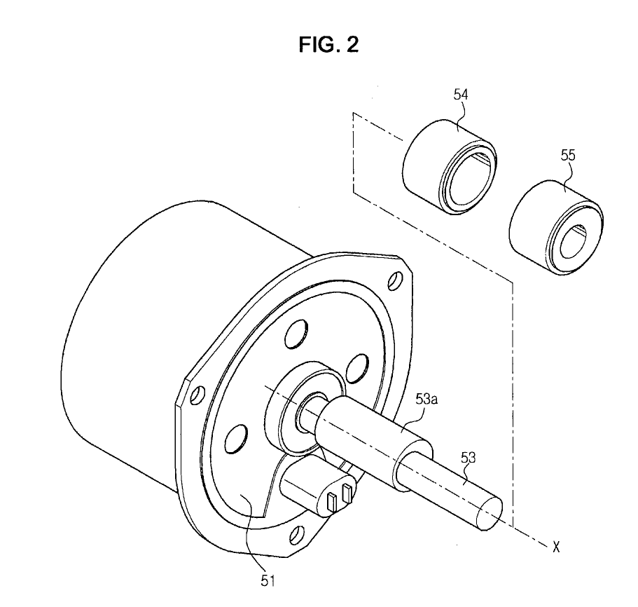

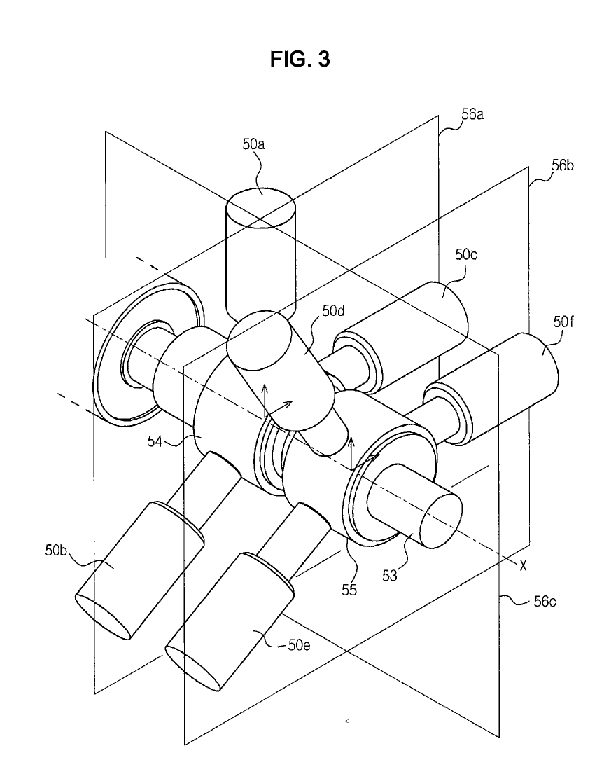

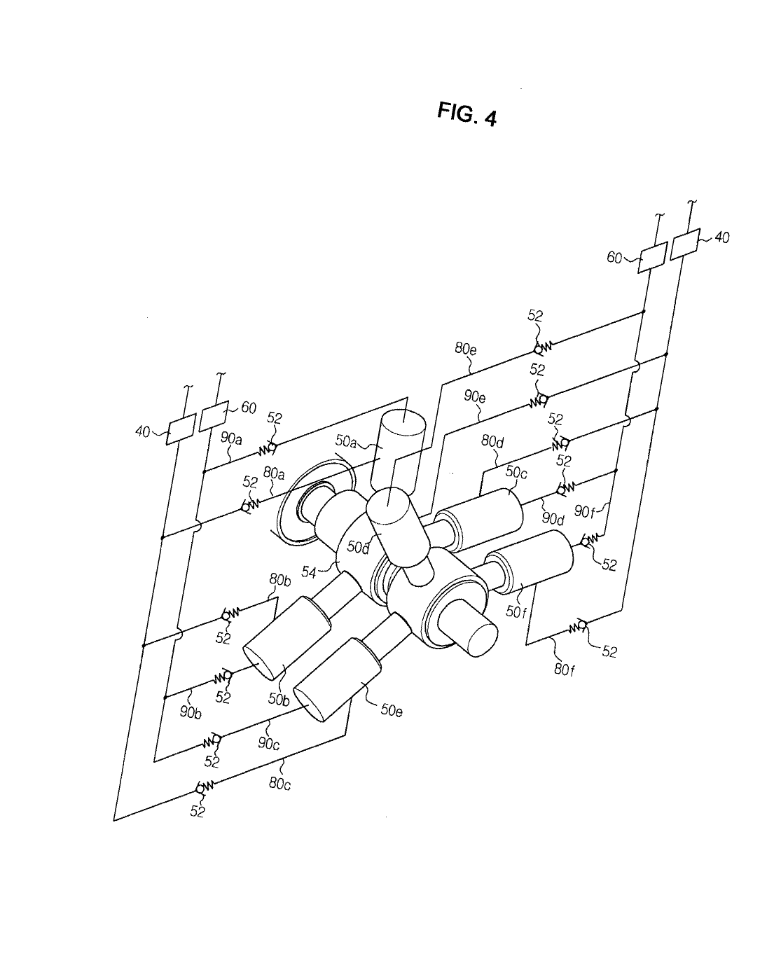

FIG. 2 is an exploded perspective view illustrating the configuration of a shaft of the motor in accordance with the embodiment of the present invention, FIG. 3 is a perspective view schematically illustrating the arrangement of the motor and pump unit in accordance with the embodiment of the present invention, and FIG. 4 is a perspective view schematically illustrating the connection of the pump unit and hydraulic circuits in accordance with the embodiment of the present invention.

As illustrated in FIG. 2, a single motor 51 is used to drive the pump unit 50. The motor 51 has a shaft 53 to be rotated about a rotating axis X.

An eccentric portion 53a is integrally provided on a lower portion of the shaft 53 so as to be eccentric in a given direction from the rotating axis X. A concentric bearing 54 is press-fitted around the eccentric portion 53a. The concentric bearing 54 includes concentric inner and outer rings.

An eccentric bearing 55 is concentrically press-fitted on the shaft 53 at a position above the eccentric portion 53a. The eccentric bearing 55 includes inner and outer rings, center points of which are spaced apart from each other by a predetermined distance.

Specifically, the shaft 53 includes the two bearings 54 and 55 arranged at different positions spaced apart from each other in a direction of the rotating axis X, to allow the concentric bearing 54 operatively assembled to the eccentric portion 53a of the shaft 53 and the eccentric bearing 55 operatively assembled to the shaft 53 at a position spaced apart upward from the concentric bearing 54 to be rotated with a predetermined phase difference.

The concentric bearing 54 and eccentric bearing 55 are connected to corresponding positions of the pump unit 50 that will be described hereinafter, to operate the pump unit 50.

In this way, as load is sequentially applied to the pump unit 50 including the six pumps that will be described hereinafter, it may be possible to prevent excessive load from being applied to the bearings 54 and 55 and shaft 53 of the motor 51, resulting in enhanced durability and lifespan.

Hereinafter, the arrangement of the pump unit 50 with respect to the bearings 54 and 55 press-fitted to the shaft 53 of the motor 51 will be described.

Referring to FIG. 3, there are illustrated a first plane 56a, a second plane 56b and a third plane 56c. The third plane 56c contains the rotating axis X of the motor shaft 53. The first pump 50a is arranged on the third plane 56c and has a center axis intersecting at a right angle with the rotating axis X of the shaft 53. The first plane 56a intersects at a right angle with the rotating axis X of the shaft 53 and is located to correspond to the concentric bearing 54 to contain the center axis of the first pump 50a. The second plane 56b is parallel to the first plane 56a and is spaced apart from the first plane 56a by a predetermined distance to correspond to the eccentric bearing 55.

The first pump 50a, second pump 50b and third pump 50c are arranged on the first plane 56a. The second pump 50b has a center axis, which intersects at a right angle with the rotating axis X of the shaft 53 and is rotated counterclockwise about the rotating axis X by 120 degrees from the center axis of the first pump 50a. The third pump 50c has a center axis, which intersects at a right angle with the rotating axis X of the shaft 53 and is rotated counterclockwise about the rotating axis X by 270 degrees from the center axis of the first pump 50a.

The fourth pump 50d, fifth pump 50e and sixth pump 50f are arranged on the second plane 56b. The fourth pump 50d has a center axis, which intersects at a right angle with the rotating axis X and is rotated counterclockwise about the rotating axis X by 30 degrees from the center axis of the first pump 50a. The fifth pump 50e has a center axis, which intersects at a right angle with the rotating axis X of the shaft 53 and is rotated counterclockwise about the rotating axis X by 90 degrees from the center axis of the fourth pump 50d. The sixth pump 50f has a center axis, which intersects at a right angle with the rotating axis X of the shaft 53 and is rotated counterclockwise about the rotating axis X by 240 degrees from the center axis of the fourth pump 50d.

In the present embodiment, as illustrated in FIG. 4, the first pump 50a and second pump 50b arranged on the first plane 56a and the fifth pump 50e arranged on the second plane 56b may be connected to the first hydraulic circuit A, and the third pump 50c arranged on the first plane 56a and the fourth pump 50d and sixth pump 50f arranged on the second plane 56b may be connected to the second hydraulic circuit B.

With the above described arrangement, in the electronically controlled brake system in accordance with the embodiment of the present invention, whenever the shaft 53 rotates once about the rotating axis X, the first and second hydraulic circuits A and B each performs generation of pressure three times. This reduces a pressure pulse period and pressure pulse width, resulting in alleviated system shaking and operation noise.

In the electronically controlled brake system of the present embodiment, suction and discharge paths of the pump unit 50 may be oriented in the same direction. This enables compact spatial arrangement of the pumps and compact path design.

Specifically, suction paths 80a, 80b, 80c, 80d, 80e and 80f and discharge paths 90a, 90b, 90c, 90d, 90e and 90f are formed in a single direction, and thus, may easily hold the low-pressure and high-pressure accumulators 40 and 60 in common. More specifically, as illustrated in FIG. 3, the three pumps 50a, 50b and 50e connected to the first hydraulic circuit A are connected at their suction sides to the single low-pressure accumulator 40 and at their discharge sides to the single high-pressure accumulator 60. The three pumps 50c, 50d and 50f connected to the second hydraulic circuit B are connected at their suction sides to the single low-pressure accumulator 40 and at their discharge sides to the single high-pressure accumulator 60. In this way, more compact design of the brake system may be possible.

Although the present embodiment illustrates the first, second and fifth pumps 50a, 50b and 50e as being connected to the first hydraulic circuit A and the third, fourth and sixth pumps 50c, 50d and 50f as being connected to the second hydraulic circuit B, this is only given by way of example, and three pumps connected to each of the first and second hydraulic circuits may be adjustable according to the configuration of the hydraulic circuits. For example, the second, fourth and fifth pumps 50b, 50d and 50e may be connected to the first hydraulic circuit A, and the first, third and sixth pumps 50a, 50c and 50f may be connected to the second hydraulic circuit B.

The hydraulic circuits in accordance with the embodiment of the present invention are given by way of example, and of course, the pump unit of the present embodiment may also be applied to other hydraulic circuits.

As is apparent from the above description, an electronically controlled brake system in accordance with an embodiment of the present invention may have the effects of assuring rapid response ability during operation of a motor and pump, enhanced durability owing to a reduction in load and operations of respective components, and comfortable pedaling and reduced operation noise owing to a reduction in hydraulic pulsation.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A pump unit for an electronically controlled brake system, which is connected to first and second hydraulic circuits that connect a master cylinder assembly and a plurality of brake cylinders to each other to define closed circuits, and is operated by a motor having a shaft to be rotated about a rotating axis,
wherein the shaft comprises a concentric shaft portion and an eccentric portion integrally formed with each other, an eccentric bearing coupled to the concentric shaft portion, and a concentric bearing coupled to the eccentric portion.

2. The pump unit according to claim 1, wherein the concentric bearing and the eccentric bearing are press-fitted respectively.

3. The pump unit according to claim 2, wherein the pump unit includes first to third pumps arranged on a first plane, which intersects at a right angle with the rotating axis at a position corresponding to the concentric bearing, so as to be connected to the concentric bearing, and fourth to sixth pumps arranged on a second plane, which intersects at a right angle with the rotating axis at a position corresponding to the eccentric bearing, so as to be connected to the eccentric bearing.

4. The pump unit according to claim 3, wherein three pumps of the first to sixth pumps are connected to the first hydraulic circuit, and the remaining three pumps are connected to the second hydraulic circuit.
